(19) United States
(12) Patent Application Publication
(10) Pub. No.: US 2026/0200045 A1
(43) Pub. Date: Jul. 16, 2026

(54) MAGNETIC BELT CLAMP

(71) Applicant: Laitram, L.L.C., Harahan, LA (US)

(72) Inventor: Christopher Dale Russo, Covington, LA (US)

(21) Appl. No.: 19/134,948

(22) PCT Filed: Nov. 17, 2023
(86) PCT No.: PCT/US2023/080364

§ 371 Date: Jun. 2, 2025

Related U.S. Application Data
(60) Provisional application No. 63/436,786, filed on Jan. 3, 2023.

(51) Int. Cl. B25B 11/00; B26D 1/04; B26D 7/02; B65G 15/42; F16G 3/00; F16G 3/10

(52) U.S. Cl. CPC B25B 11/002; B26D 1/04; B26D 7/02; F16G 3/003; F16G 3/10; B65G 15/42

(57) ABSTRACT

A magnetic belt clamp for clamping homogeneous conveyor belts for cutting or clamping. The magnetic belt clamp includes a clamp bar with one or more magnetic switches along its length. When in the on position, the magnetic switches attract ferromagnetic material in a belt aligner below to clamp a section of a conveyor belt in a gap between the bottom of the clamp bar and the aligner. The aligner has alignment structure on a deck that receives salient belt features to register the belt with respect to a guide track along which a cutting assembly is slid to cut on a precise line across the belt. Belt cutters or magnetic clamps can be readily mounted on a belt splicer to clamp the butt ends of a belt to be spliced.

### BACKGROUND

The invention relates to magnetic clamping tools for flexible plastic conveyor belts.

Belt cutters are used to cut flexible plastic conveyor belts, such as the THERMODRIVE® line of homogeneous thermoplastic conveyor belts sold by Intralox, L.L.C., of Harahan, Louisiana, U.S.A., to prescribed lengths and to make precisely oriented cuts at belt ends before they are welded together. Precise cuts are especially important in belts with regularly spaced drive teeth. If the cut line is not precisely positioned relative to the teeth, the tooth spacing across the welded cut ends will not match the regular tooth spacing, or pitch, of the rest of the belt. Handheld belt cutters can be used, but the human operator has to hold the belt while cutting across the belt's width with the handheld belt cutter. Clamps are used to stabilize belts for cutting or splicing. The clamps clamp the belt only at its side edges, which often results in some play in an interior region of the belt. As the cutter traverses the undulations in the unclamped interior region of the belt, the cut can deviate from straight.

### SUMMARY

One version of a magnetic belt clamp comprises a clamp bar that extends in length from a first end to a second end, in width from a front side to a rear side, and in thickness from a top to a bottom. One or more magnetic switches are mounted in the clamp bar. A belt aligner is situated across a gap from the clamp bar and includes a ferromagnetic material and a deck facing the clamp bar across the gap. Alignment structure in the deck is suitable for receiving salient features on a face of a plastic conveyor belt received in the gap to register the conveyor belt. The one or more magnetic switches are manually adjusted between an off position producing no magnetic attraction to the ferromagnetic material in the belt aligner and an on position attracting the belt aligner toward the bottom of the clamp bar and clamping the conveyor belt in the gap between the belt aligner's deck and the clamp bar.

One version of a belt cutter comprises a magnetic clamp that includes a clamp bar that extends in length from a first end to a second end, in width from a front side to a rear side, and in thickness from a top to a bottom. A series of mounting holes extend through the thickness of the clamp bar from the top to the bottom along the length of the clamp bar. Magnetic switches are each mounted in an individual mounting hole. A belt aligner is situated across a gap from the clamp bar. The belt aligner includes a ferromagnetic material and a deck facing the bottom of the clamp bar across the gap. Alignment structure in the deck receives salient features on a face of a plastic conveyor belt received in the gap to register the conveyor belt. The magnetic switches are manually adjusted between an off position producing no magnetic attraction to the ferromagnetic material in the belt aligner and an on position attracting the belt aligner toward the bottom of the clamp bar and clamping the conveyor belt in the gap between the belt aligner's deck and the bottom of the clamp bar. The belt cutter also comprises a guide track fastened to the front side of the clamp bar and extending along its length and a cutting assembly that includes a cutting blade and a carriage slidably attached to the guide track to slide along the guide track and cut though the conveyor belt clamped in the gap along a line outside the gap.

### BRIEF DESCRIPTION OF THE DRAWINGS

FIG. 1 is an isometric view of a belt cutter including a magnetic belt clamp embodying features of the invention.

FIG. 2 is an exploded view of the belt cutter of FIG. 1.

FIG. 3 is an isometric view of a belt aligner usable in the magnetic clamp of FIG. 1.

FIG. 4 is an isometric view of two belt cutters as in FIG. 1 used in a belt splicer.

FIG. 5 is a front elevation view of the belt splicer of FIG. 4.

FIG. 6 is a top plan view of the clamp bar of a second version of a magnetic belt clamp.

FIG. 7 is a top plan view of the clamp bar of an electromagnetic version of a magnetic belt clamp.

### DETAILED DESCRIPTION

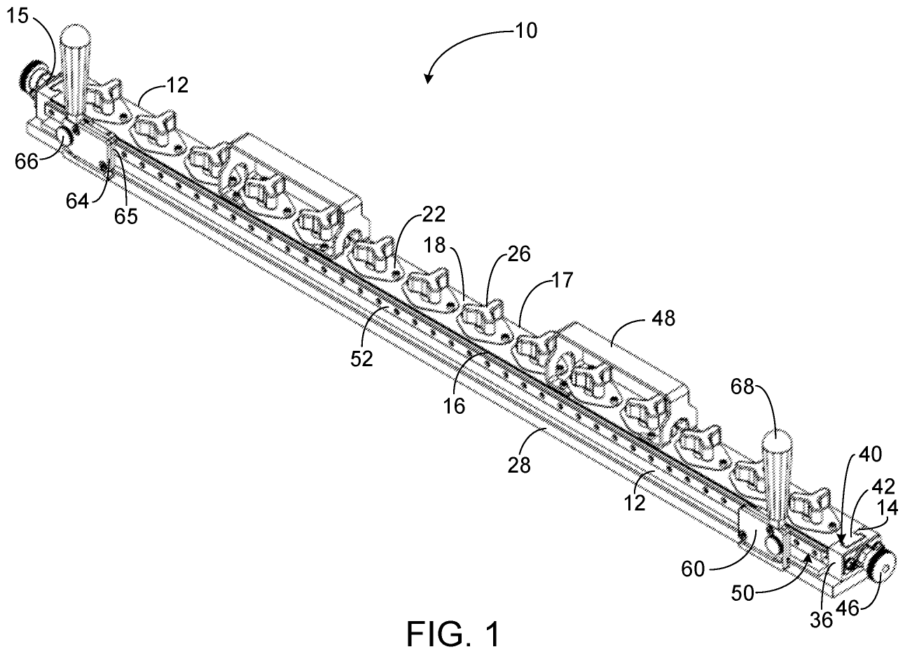

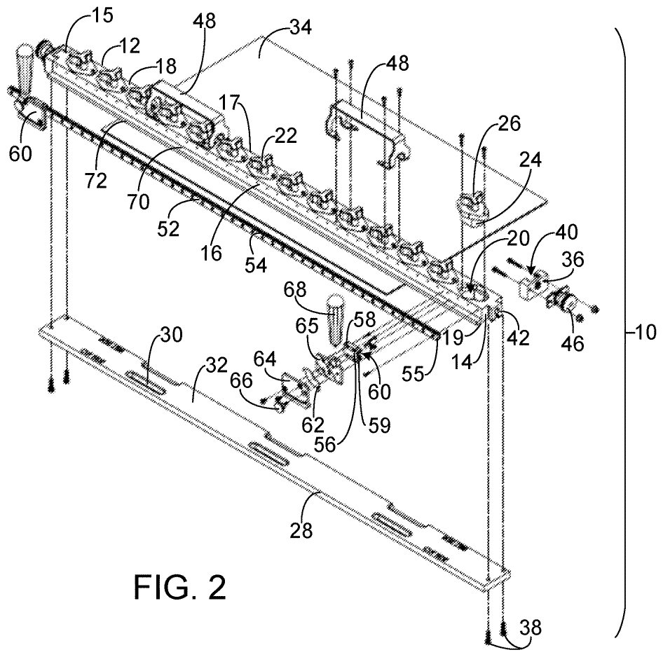

One version of a belt cutter with a magnetic clamp embodying features of the invention is shown in FIGS. 1 and 2. The cutter 10 includes a magnetic clamp having a clamp bar 12 that extends in length from a first end 14 to a second end 15, in width from a front side 16 to a rear side 17, and in thickness from a top 18 to a bottom 19. A series of mounting holes 20 extend through the thickness of the clamp bar 12 from the top 18 to the bottom 19. In this version the mounting holes 20 are regularly spaced in line along the length of the clamp bar 12. But the spacing could be irregular or staggered instead. A magnetic switch 22, such as a magswitch® MAGJIG sold by Magswitch USA, of Superior, Colorado, U.S.A., is mounted in each mounting hole 20. In this version fourteen magnetic switches are used, but it would be possible to use more or fewer than fourteen.

The magnetic switch 22 has two identical stacked diametrically polarized permanent magnets in a ferromagnetic housing 24. The lower magnet is stationary, while the upper magnet can be rotated by a top knob 26. When the knob 26 is rotated to an off position, the north pole of the upper magnet is directly above the south pole of the lower magnet, and the south pole of the upper magnet is directly above the north pole of the lower magnet. In that arrangement the magnetic flux is substantially confined to the housing 24 and the two magnets; little or no magnetic flux, and thus no force of magnetic attraction, is produced outside the switch 20. When the magnetic switch 20 is rotated to the on position, the north pole of the upper magnet is directly above the north pole of the lower magnet, and the south pole of the upper magnet is directly above the south pole of the lower magnet. In that arrangement the two magnets are effectively a single magnet producing magnetic flux outside the magnetic switch 20 that can attract nearby external ferromagnetic materials.

A belt aligner 28 is situated below the clamp bar 12. The belt aligner 28 has alignment structure in the form of elongated slots 30 recessed into a top deck 32 of the belt aligner. The elongated slots 30 receive complementarily shaped salient features, such as drive lugs, in the bottom face of a flexible conveyor belt 34 to be cut. Belts with different salient features can be accommodated by different belt aligners having corresponding complementary alignment structure in the top deck.

Side rails 36 at the first and second ends 14, 15 of the clamp bar 12 are fastened to the ends of the belt aligner 28 by screws 38. The side rails 36 have vertical raceways 40 in which sliders 42 at the first and second ends 14, 15 of the clamp bar 12 can slide vertically. When the sliders 42 are in the raceways 40, the clamp bar 12 and the belt aligner 32 are in registration. Handles 48 on the top of the clamp bar 12 are used to lift and lower the clamp bar relative to the belt aligner 32. Spring plungers 46 attached at the outer side of the side rails 36 have shafts that extend through the side rails into contact with the sliders 42 to stabilize the clamp bar 12. The plungers, when retracted, release the clamp bar 12 so that it can be lifted upward along the side rails 36 by the handles 48 on the top 18 of the clamp bar.

A section of the belt 34 is positioned atop the belt aligner 28 with the aligner's slots 30 receiving the conveyor belt's drive lugs. The clamp bar 12 is lowered along the side rails 36 to sit atop the belt 34. The magnetic switches 22 are switched to their on positions, which results in an attractive force between the switches and the ferromagnetic material in the belt aligner 28. The magnetic force of attraction tightly clamps and stabilizes the conveyor belt 34 in a gap 50 between the belt aligner 28 and the clamp bar 12. The closely spaced magnetic switches 22 clamp the belt with pressure applied generally uniformly across its entire width—not just at its outer sides.

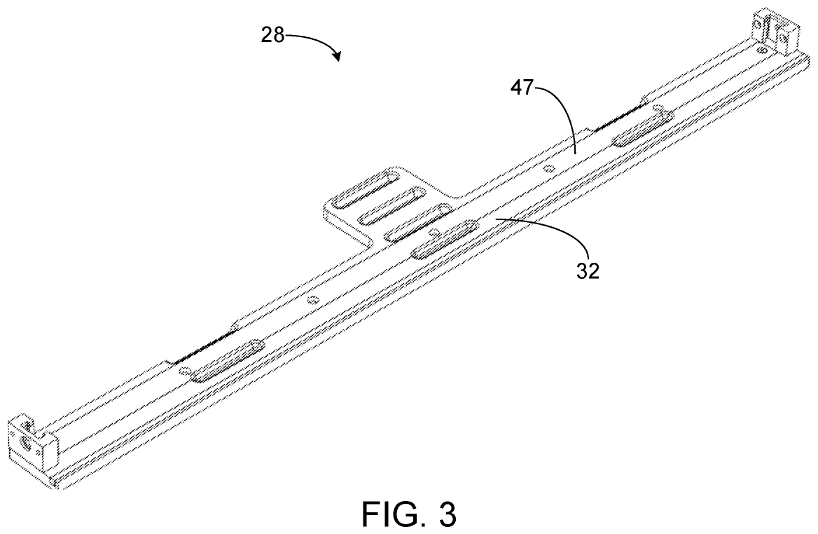

The belt aligner 28 is shown in more detail in FIG. 3. A ferromagnetic insert 47 made of carbon steel or another ferromagnetic material is fastened to the aligner 28 in a recess in its deck 32 directly across the gap 50 from the magnetic switches 22 of FIG. 2. The rest of the belt aligner 28 can be made of aluminum for reduced weight. But the entire belt aligner could be made of carbon steel or another ferromagnetic material.

A guide track 52 is fastened to the front face 16 of the clamp bar 12. The guide track 52 has upper and lower grooves 54, 55. A carriage 56 has upper and lower feet 58, 59 that hook into the upper and lower grooves 54, 55 of the guide track 52. The carriage 56 is part of a cutting assembly 60 that also includes a cutting blade 62 and two blade-housing halves 64, 65. The cutting blade 62 is sandwiched between the two housing halves 64, 65, which are closed around the blade by screws. A thumb screw 66 in the outer housing half 64 enables toolless blade replacement. The inner housing half 65 is fastened to the carriage 58. A cutter handle 68 is used to manually slide the cutting assembly 60 along the guide track 52.

A ledge 70 extends outward of the front side 16 of the clamp bar 12 below the guide track 52. The ledge 70 terminates in a vertical wall forming a straight edge 72. Because the straight edge 72 is part of the clamp bar 12 and the clamp bar is registered with the belt aligner 28 and, therefore, with the conveyor belt 34 itself, sliding the cutting assembly 60 along the straight edge of the ledge 70 cuts the belt along a precise line across the belt's width a known distance from the belt's salient features and outside the gap 50. Two cutting assemblies 60 are shown in FIGS. 1 and 2 so that an operator can use whichever one is more convenient. But the belt cutter 10 could be made with a single cutting assembly 60.

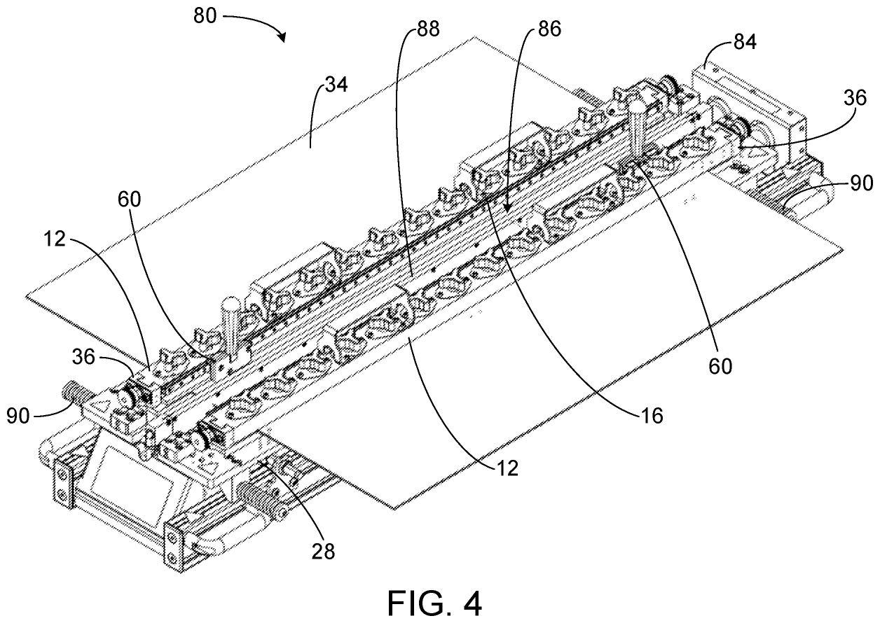

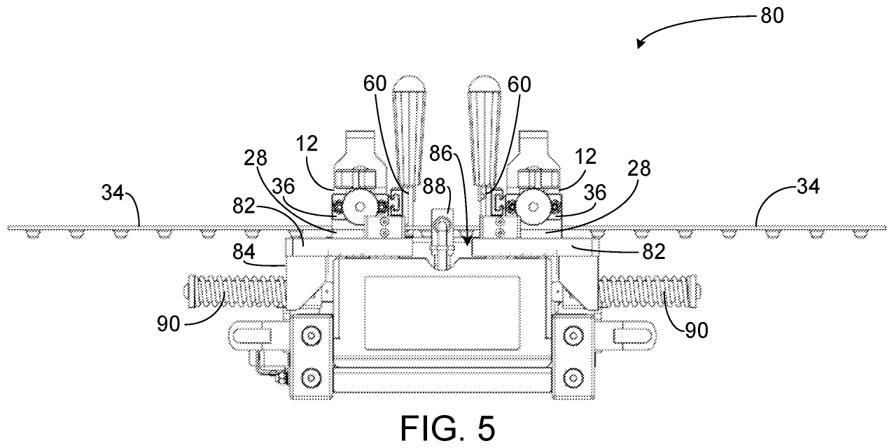

Two belt cutters with the magnetic clamp as in FIGS. 1 and 2 are used in a belt cutter and splicer 80 in FIGS. 4 and 5. The belt aligners 28 and the side rails 36 are adapted to be readily mounted atop confronting jaws 82 of a belt splicer 84. The jaws 82 are separated by a space 86. The clamp bars 12 are received in the side rails 36. The cutting assemblies 60 at the front faces 16 of the clamp bars 12 face each other across the space 86 and can be used to trim the ends of the belt 34. If belt cutting isn't required, the cutting assemblies 60 and the guide tracks 52 can be eliminated. A heating wand 88 is movable into the space 86 from below. The splicer 84 includes a mechanism that: (a) closes the jaws 82 to move butt ends of a conveyor belt 34 together into contact with the sides of the heated heating wand 88 that melts the butt ends; (b) retracts the butt ends from contact with the sides of the heating wand and moves the heating wand out of the space 86; (c) moves the melted butt ends together in the space to splice them; and (d) releases the jaws when the cooling of the joined butt ends and the splicing is completed.

Springs 90 at the ends of each of the jaws 82 are compressed as the jaws move toward each other. The energy stored in the compressed springs 90 is used to rapidly separate the melted belt ends from the sides of the heating wand 88 so that the wand can be moved out of the space 88 and the melted belt ends moved together to form the splice. Further details of the splicer mechanism are found in U.S. Pat. No. 9,796,135, issued Oct. 14, 2017, to Laitram, L.L.C. The disclosure of that patent is incorporated into this application by reference.

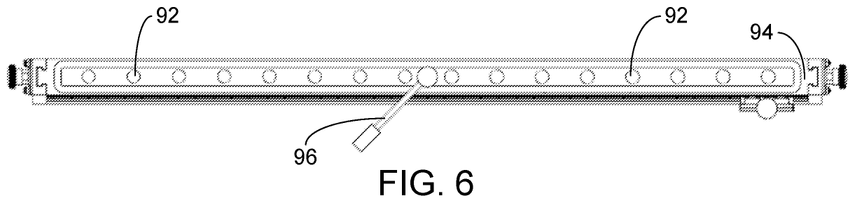

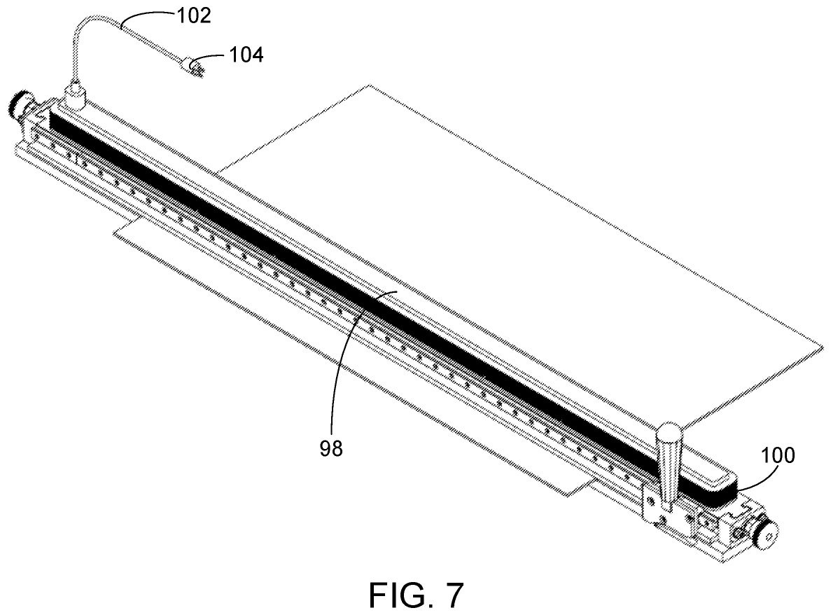

FIGS. 6 and 7 depict alternative versions of a magnetic belt clamp shown in conjunction with a guide track and cutting assembly. In FIG. 6 a plurality of magnetic switches 92 are embedded in a clamp bar 94 at spaced apart locations across its width. A single on/off lever 96 is coupled to all the magnetic switches 92 by a rack-and-pinion arrangement, a timing-belt-and-gear arrangement, or an equivalent arrangement that allows all the magnetic switches to be switched between the on and off positions simultaneously. Instead of permanent magnets, the clamp bar 98 in FIG. 7 has a coil 100 wound along its periphery to form an electromagnetic belt clamp. The coil can have a ferrite core. Electric power is supplied to the coil by a power cord 102 that terminates in a plug 104 that can be plugged into a source of electric power, such as a standard outlet. Or electric power can be supplied by a battery. Although not shown, a conventional on/off switch in line with the cord 102 or integral to the clamp bar 98 allows the magnetic clamp to be switched on and off. In that way, the electromagnets, which can be selectively switched on and off by the on/off switch are magnetic switches. Instead of a single coil as in FIG. 7, a plurality of electromagnets connected electrically in parallel could be spaced apart across the clamp bar to produce the magnetic force of attraction.

All the magnetic clamps described in the preceding description can be switched on and off and so have what may be referred to as magnetic switches that selective produce a uniform magnetic force of attraction along the entire length of the clamp bars to apply a generally uniform clamping force across the entire width of the conveyor belt. Alternatively, non-switchable permanent magnets could be installed in a clamp bar to achieve an equivalent uniform clamping force on a conveyor belt.

What is claimed is:

1. A magnetic belt clamp comprising:
a clamp bar extending in length from a first end to a second end, in width from a front side to a rear side, and in thickness from a top to a bottom;
one or more magnetic switches mounted in the clamp bar;
a belt aligner situated across a gap from the clamp bar and including:
a ferromagnetic material;
a deck facing the clamp bar across the gap;
alignment structure in the deck for receiving salient features on a face of a plastic conveyor belt received in the gap to register the conveyor belt;
wherein the one or more magnetic switches are manually adjusted between an off position producing no magnetic attraction to the ferromagnetic material in the belt aligner and an on position attracting the belt aligner toward the bottom of the clamp bar and clamping the conveyor belt in the gap between the belt aligner's deck and the clamp bar.

2. The magnetic belt clamp as claimed in claim 1 comprising a belt cutter including:
a guide track fastened to the front side of the clamp bar and extending along its length;
a cutting assembly including a cutting blade and a carriage slidably attached to the guide track to slide along the guide track and cut though the conveyor belt clamped in the gap along a line outside the gap.

3. The magnetic belt clamp as claimed in claim 2 wherein the clamp bar includes a ledge protruding from the front side to a straight edge and wherein the cutting assembly rides along the straight edge to ensure a straight cut through the clamped conveyor belt.

4. The magnetic belt clamp as claimed in claim 2 wherein the cutting assembly includes a handle for manually sliding the carriage along the guide track to cut the conveyor belt clamped in the gap.

5. The magnetic belt clamp as claimed in claim 2 comprising a second cutting assembly including a cutting blade and a carriage slidably attached to the guide track to slide along the guide track and cut though the conveyor belt clamped in the gap along a line outside the gap.

6. The magnetic belt clamp as claimed in claim 1 comprising a plurality of the magnetic switches and wherein the clamp bar includes a series of mounting holes extending through the thickness of the clamp bar from the top to the bottom along the length of the clamp bar and wherein each of the magnetic switches is mounted in an individual mounting hole.

7. The magnetic belt clamp as claimed in claim 1 comprising:
side rails fastened to the belt aligner and having vertical raceways;
wherein the clamp bar has sliders at the first and second ends that ride in the vertical raceways of the side rails;
a handle on the top of the clamp bar for lifting and lowering the clamp bar.

8. The magnetic belt clamp as claimed in claim 8 comprising spring plungers extending through the side rails to stabilize the clamp bar and to release the clamp bar for removing the conveyor belt from the gap.

9. The magnetic belt clamp as claimed in claim 1 wherein the ferromagnetic material causes the belt aligner to be magnetically attracted to the one or more magnetic switches in the clamp bar when the one or more magnetic switches are in the on position.

10. The magnetic belt clamp as claimed in claim 1 wherein the alignment structure comprises one or more slots recessed into the deck of the belt aligner.

11. The magnetic belt clamp as claimed in claim 1 wherein the one or more magnetic switches comprise two identical stacked diametrically polarized permanent magnets in a ferromagnetic housing, wherein one of the two permanent magnets is rotatable between an on position in which like poles of the two permanent magnets are aligned and an off position in which opposite poles of the two permanent magnets are aligned.

12. The magnetic belt clamp as claimed in claim 1 wherein the one or more magnetic switches comprise one or more coils forming one or more electromagnets.

13. A belt splicer for splicing butt ends of a conveyor belt together, the belt splicer comprising:
two confronting jaws spaced apart across a space;
a heating wand movable into the space between the jaws;
a mechanism for closing the jaws to move the butt ends into contact with the heating wand to melt the butt ends, for releasing the jaws to move the butt ends out of contact with the heating wand and moving the heating wand out of the space, for closing the jaws to move the melted butt ends together to splice the butt ends, and for releasing the jaws when the splicing of the butt ends together is completed;
two magnetic belt clamps as claimed in claim 1 clamping opposing ends of a conveyor belt to be spliced;
wherein the front sides of the two clamp bars face each other across the space; and
wherein the two belt aligners are mounted on the two confronting jaws.

14. A belt cutter comprising:
a magnetic clamp including:
a clamp bar extending in length from a first end to a second end, in width from a front side to a rear side, and in thickness from a top to a bottom, and including a series of mounting holes extending through the thickness of the clamp bar from the top to the bottom along the length of the clamp bar;
a plurality of magnetic switches, each mounted in an individual mounting hole;
a belt aligner situated below the bottom of the clamp bar across a gap extending the length of the clamp bar and including:
a ferromagnetic material;
a deck facing the bottom of the clamp bar across the gap;
alignment structure in the deck for receiving salient features on a face of a plastic conveyor belt received in the gap to register the conveyor belt;
wherein the magnetic switches are manually adjusted between an off position producing no magnetic attraction to the ferromagnetic material in the belt aligner and an on position attracting the belt aligner toward the bottom of the clamp bar and clamping the conveyor belt in the gap between the belt aligner's deck and the bottom of the clamp bar;
a guide track fastened to the front side of the clamp bar and extending along its length;
a cutting assembly including a cutting blade and a carriage slidably attached to the guide track to slide along the guide track and cut though the conveyor belt clamped in the gap along a line outside the gap.
